(19) United States
(12) Patent Application Publication
(10) Pub. No.: US 2020/0174432 A1
(43) Pub. Date: Jun. 4, 2020

(54) ACTION DETERMINING METHOD AND ACTION DETERMINING APPARATUS

(71) Applicant: FUJITSU LIMITED, Kawasaki-shi (JP)

(72) Inventor: Hidenao Iwane, Kawasaki (JP)

(73) Assignee: FUJITSU LIMITED, Kawasaki-shi (JP)

(21) Appl. No.: 16/697,455

(22) Filed: Nov. 27, 2019

(30) Foreign Application Priority Data
Dec. 4, 2018 (JP) 2018-227718

(51) Int. Cl. G05B 13/04; G05B 13/02; G05D 1/00

(52) U.S. Cl. CPC G05B 13/041; G05D 1/0088; G05B 13/0265

(57) ABSTRACT

A non-transitory computer-readable recording medium having stored therein a program for causing a computer to execute a process. The process includes obtaining a specific action related to a value function that becomes a polynomial expression for a variable that represents an action or a polynomial expression for a variable that represents an action when a value is substituted for a variable that represents a state. The process includes specifying an action range by using a quantifier elimination for a logical expression including a conditional expression that represents that a difference between a value of the value function and a value of the value function that corresponds to the specific action is smaller than a threshold value. The process includes determining a next action from the specified range.

### CROSS-REFERENCE TO RELATED APPLICATION

This application is based upon and claims the benefit of priority of the prior Japanese Patent Application No. 2018-227718, filed on Dec. 4, 2018, the entire contents of which are incorporated herein by reference.

### FIELD

The embodiment discussed herein is related to an action determining method, and an action determining apparatus.

### BACKGROUND

In the related art, in the field of reinforcement learning, a value function that indicates a cumulative gain of a control target is estimated, and an optimum action determined to be optimum is determined as an action on the control target based on the value function. The gain is, for example, a reward. The value function is, for example, a state action value function (Q function). For example, the value function is estimated based on the gain that corresponds to the action by randomly selecting an action on the control target.

Japanese Laid-open Patent Publication Nos. 2012-68870 and 2015-102263 are examples of related art.

### SUMMARY

According to an aspect of the embodiments, a non-transitory computer-readable recording medium having stored a program for causing a computer to execute a process including obtaining, for a control target, an specific action related to a value function that becomes a polynomial expression for a variable that represents an action or a polynomial expression for a variable that represents an action when a value is substituted for a variable that represents a state; specifying an action range by using a quantifier elimination for a logical expression including a conditional expression that represents that a difference between a value of the value function and a value of the value function that corresponds to the specific action is smaller than a threshold value; determining a next action from the specified range; and transmitting, to the control target, a control signal to effectuate the next action from the specified range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an action determining method according to an embodiment;

FIG. 2 is a block diagram illustrating a hardware configuration example of an action determining apparatus;

FIG. 3 is an explanatory diagram illustrating an example of stored contents of a coefficient array;

FIG. 4 is an explanatory diagram illustrating an example of stored contents of a history table;

FIG. 5 is a block diagram illustrating a functional configuration example of the action determining apparatus;

FIG. 6 is an explanatory diagram (part 1) illustrating a flow of reinforcement learning in an example;

FIG. 7 is an explanatory diagram (part 2) illustrating a flow of the reinforcement learning in the example;

FIG. 8 is an explanatory diagram (part 3) illustrating a flow of the reinforcement learning in the example;

FIG. 9 is an explanatory diagram (part 4) illustrating a flow of the reinforcement learning in the example;

FIG. 10 is an explanatory diagram (part 5) illustrating a flow of the reinforcement learning in the example;

FIG. 11 is an explanatory diagram (part 1) illustrating a specific example of a control target;

FIG. 12 is an explanatory diagram (part 2) illustrating a specific example of the control target;

FIG. 13 is an explanatory diagram (part 3) illustrating a specific example of the control target;

FIG. 14 is a flowchart illustrating an example of a reinforcement learning processing procedure;

FIG. 15 is a flowchart illustrating an example of an action determining processing procedure; and

FIG. 16 is a flowchart illustrating another example of the action determining processing procedure.

### DESCRIPTION OF EMBODIMENTS

For example, in the technologies disclosed in Japanese Laid-open Patent Publication No. 2012-68870 and Japanese Laid-open Patent Publication No. 2015-102263, when the value function is estimated, the action on the control target is randomly selected, and as a result, there is a case where the action on the control target becomes an action having a relatively low value. When the control target is an unmanned air vehicle, there is a case where the action on the control target becomes an action that makes a stable fly difficult, and there is a case where the control target falls.

Hereinafter, with reference to the drawings, an embodiment of an action determining program, an action determining method, and an action determining apparatus according to the present embodiment will be described in detail.

One Example of Action Determining Method According to Embodiment

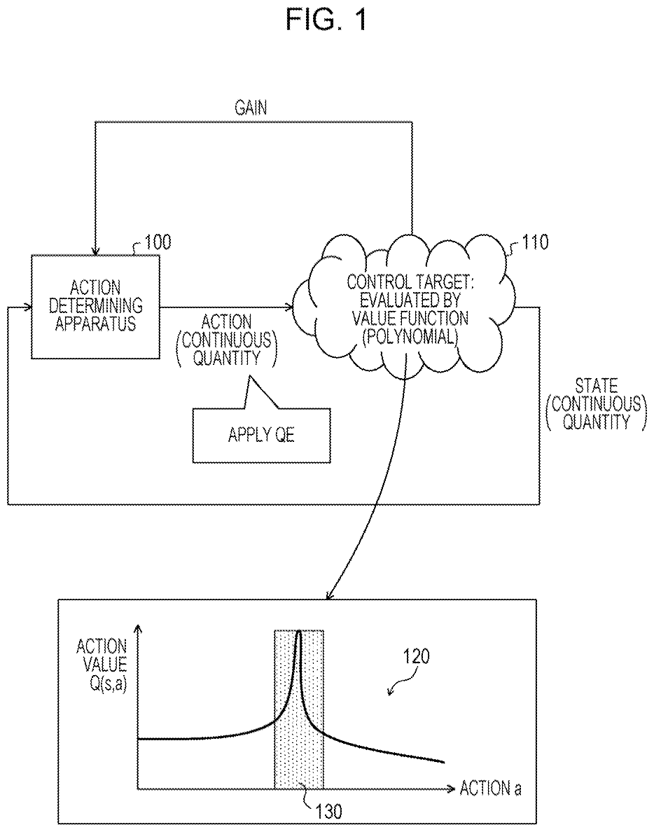

FIG. 1 is an explanatory diagram illustrating an example of the action determining method according to an embodiment. An action determining apparatus 100 is a computer that controls a control target 110 by determining an action on the control target 110 by using reinforcement learning. The action determining apparatus 100 is, for example, a server, a personal computer (PC), or the like.

The control target 110 is some event, for example, a physical system. Specifically, the control target 110 is an automobile, an autonomous mobile robot, a drone, a helicopter, a server room, a generator, a chemical plant, a game, or the like.

The action is an operation with respect to the control target 110. The action is also called input. A state of the control target 110 changes corresponding to the action on the control target 110. The state of the control target 110 is observable.

In the reinforcement learning, for example, the value function that indicates a cumulative gain of the control target 110 is estimated based on the gain that corresponds to the action by randomly selecting an action on the control target 110. The gain is, for example, a reward. The gain is, for example, a value obtained by multiplying the cost by a negative value, and may be a value that makes it possible to be treated as a reward. The estimation of the value function corresponds to estimation of a coefficient used for the value function, for example. The coefficient is multiplied by a polynomial expression and is multiplied by a variable that represents an action or a variable that represents a state. Specifically, the coefficient is wᵢ which will be described later.

Here, in the reinforcement learning, there is a case where the action is treated as a discrete quantity. In a case where the action is treated as a discrete quantity, for example, an ε greedy method or Boltzmann selection is used as a search action method for estimating the value function. The ε greedy method is a method for randomly selecting an action and estimating a value function. The Boltzmann selection is a method for estimating a value function by making it difficult to select an action having a relatively low value based on the value of the value function that corresponds to all possible actions.

Meanwhile, in order to adjust the action finely and control the control target 110 efficiently, there is a case where the action is treated as a continuous quantity in the reinforcement learning. In a case where the action is treated as a continuous quantity, it is considered to use, for example, a method using an ε greedy method or a noise term as a method for estimating the value function. The method using a noise term is a method for estimating a value function by selecting an action obtained by adding a noise term to an optimum action determined to be optimum from the value of the current value function.

However, in a case where the action is treated as a continuous quantity in the reinforcement learning, when the value function is estimated, the action on the control target 110 becomes an action having a relatively low value. The action having a relatively low value is, for example, an action having a value lower than a certain value compared to the optimum action. For example, in a case where the action is treated as a continuous quantity, by the s greedy method or the method using a noise term, it is not possible to suppress that the action on the control target 110 becomes an action having a relatively low value.

Specifically, as a kurtosis of a graph 120 that represents the relationship between an action a on the control target 110 in a certain state s and a value Q(s, a) of the action a increases, a change in the value Q(s, a) of the action a on the change in the action a increases, and a possibility of becoming an action having a relatively low value action increases. For example, even when the action a is changed within a range 130 close to the optimum action by the method using a noise term, there is a case where an action having a value lower than a certain value compared to the optimum action is selected.

As a result, it is not possible to efficiently control the control target 110, and an advantage of the control target 110 is caused. For example, when the control target 110 is an unmanned air vehicle, there is a case where the action on the control target 110 becomes an action that makes a stable fly difficult, and there is a case where the control target 110 falls. For example, when the control target 110 is a competition type game, there is a case where the action on the control target 110 is an action that makes the game situation too disadvantageous, and there is a case where it becomes difficult to make up for the game situation thereafter.

For example, it is considered to apply the Boltzmann selection to a case where the action is treated as a continuous quantity. However, in the Boltzmann selection, the value of the value function that corresponds to all of the actions that are continuous quantities is calculated, an enormous processing amount is caused, and thus, it is difficult to apply the Boltzmann selection to a case where the action is treated as a continuous quantity.

In the reinforcement learning, for example, based on the observed state of the control target 110, the action on the control target 110 up to the current time, and the estimated value function, the next action such that the value of the value function becomes the optimum value is determined. The optimum value is, for example, the maximum value. Therefore, when estimating the value function, there is a tendency that it is desired that the value function is accurately estimated in the range where the value of the value function is close to the optimum value.

Here, in the embodiment, an action determining method in which the quantifier elimination is applied to a logical expression including a conditional expression that represents that the difference between the value of the value function and the value of the value function that corresponds to the optimum action is equal to or less than a threshold value, and an action range is limited, will be described. Accordingly, by the action determining method, it is possible to stop the action having a relatively low value from being determined as an action on the control target 110.

The quantifier elimination is also called QE. In the following description, there is a case where the quantifier elimination is expressed as “QE”. The quantifier elimination is to convert a logical expression described using a quantifier into a logical expression that does not use a quantifier. The quantifier is a universal quantifier (∀) and an existential quantifier (∃). The universal quantifier (∀) is a symbol that targets a variable and modifies such that a logical expression is established even in a case where the variable is any value. The existential quantifier (∃) is a symbol that targets a variable and modifies such that one or more values of the variables by which the logical expression is established exist.

In FIG. 1, the action determining apparatus 100 obtains the optimum action related to the value function. The value function is, for example, a state action value function. The state action value function is, for example, a function that becomes a polynomial expression for a variable that represents the action, or a polynomial expression for a variable that represents the action when a value is substituted for a variable that represents the state. The optimum action is an action determined to be optimum based on the current value function. For example, the action determining apparatus 100 observes and stores the state of the control target 110 at predetermined time intervals. The action determining apparatus 100 stores actions on the control target 110 every predetermined time. The action determining apparatus 100 obtains the optimum action based on the stored state, action, and value function. Specific examples for obtaining the optimum action will be described later in the example.

The action determining apparatus 100 specifies the action range by using the QE for the logical expression including the conditional expression that represents that a difference between a value of the value function and a value of the value function that corresponds to the optimum action is smaller than a threshold value. The action range may be a set of two or more divided ranges. For example, by using the QE, the action determining apparatus 100 transforms the logical expression including the conditional expression that represents that the difference between the value of the value function and the value of the value function that corresponds to the optimum action is smaller than a threshold value into a logical expression including only the variable that represents the action, and specifies a range of the variable that represents the action indicated by the transformed logical expression. Specific examples for specifying the action range will be described later in the example.

The action determining apparatus 100 determines the next action from the specified range. For example, the action determining apparatus 100 randomly selects an action included in the specified range and determines the next action. Specific examples for determining the next action will be described later in the example. Accordingly, even when the action is a continuous quantity, the action determining apparatus 100 is capable of selecting and trying the action after limiting the action range from the viewpoint of the value of the action, and is capable of reflecting the result of the trial of the action in the value function.

Therefore, even when the action is a continuous quantity, the action determining apparatus 100 is capable of stopping the action having a relatively low value from being determined as the action on the control target 110 when estimating the value function. As a result, the action determining apparatus 100 is capable of efficiently controlling the control target 110 and stopping the control target 110 from being disadvantageous. For example, when the control target 110 is an unmanned air vehicle, the action determining apparatus 100 is capable of stopping the action on the control target 110 from becoming an action that makes a stable fly difficult, and is capable of stopping the control target 110 from falling.

The action determining apparatus 100 is capable of trying an action having a relatively high value rather than the action having a relatively low value, accurately estimating the range in which the value of the value function is close to the optimum value, and efficiently estimating the value function. As a result, the action determining apparatus 100 is capable of reducing the time or processing amount required when estimating the value function.

The logical expression may further include a constraint condition that represents a possible range of the action. Accordingly, in the action determining apparatus 100, it is possible to use the constraint condition in the reinforcement learning, and to determine the next action by accurately considering the properties of the control target 110. Therefore, in the action determining apparatus 100, it is possible to apply the reinforcement learning to various types of control targets 110, and to improve the convenience of the reinforcement learning. Specific examples of making it possible to use the constraint condition will be described later in the example.

Here, a case where the action determining apparatus 100 limits the action range from the viewpoint of the value of action has been described, but the embodiment is not limited thereto. For example, there may be a case where the action determining apparatus 100 further limits the action range from the viewpoint of whether there is an action more appropriate than the current optimum action at a position far from the current optimum action.

Hardware Configuration Example of Action Determining Apparatus 100

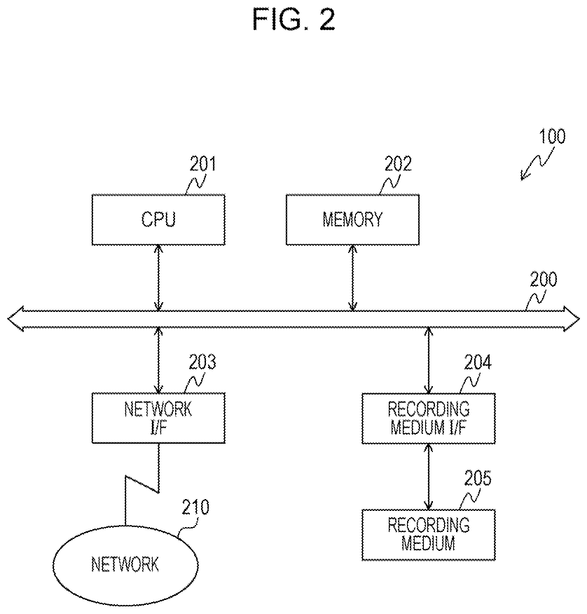

Next, a hardware configuration example of the action determining apparatus 100 will be described with reference to FIG. 2.

FIG. 2 is a block diagram illustrating a hardware configuration example of the action determining apparatus 100. In FIG. 2, the action determining apparatus 100 includes a central processing unit (CPU) 201, a memory 202, a network interface (I/F) 203, a recording medium I/F 204, and a recording medium 205. Each of the components is coupled to each other via a bus 200.

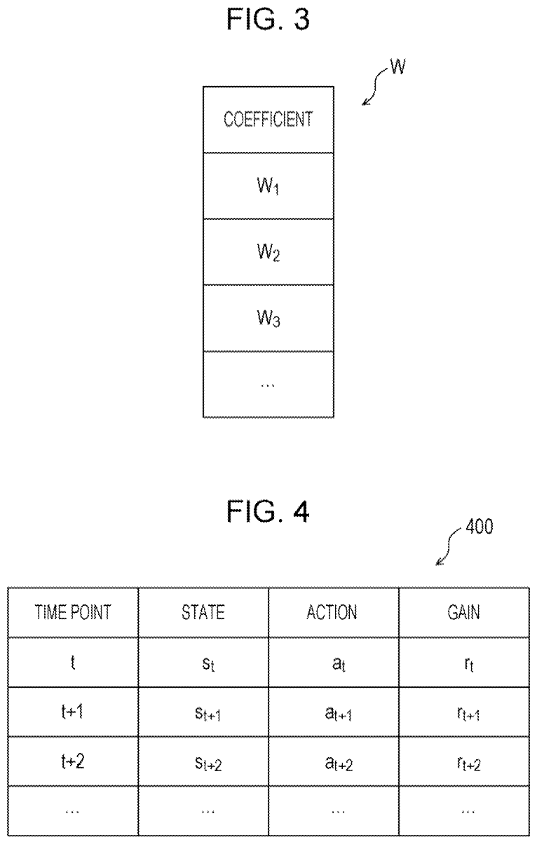

Here, the CPU 201 controls the entirety of the action determining apparatus 100. The memory 202 includes, for example, a read-only memory (ROM), a random-access memory (RAM), a flash ROM, and the like. For example, the flash ROM or the ROM stores various programs, and the RAM is used as a work area of the CPU 201. The program stored in the memory 202 causes the CPU 201 to execute coded processing by being loaded into the CPU 201. The memory 202 may store a coefficient array W which will be described later in FIG. 3 and a history table 400 which will be described later in FIG. 4.

The network I/F 203 is coupled to the network 210 through a communication line and is coupled to another computer via the network 210. The network I/F 203 controls the network 210 and an internal interface so as to control data input/output from/to the other computer. As the network I/F 203, for example, it is possible to adopt a modem, a local area network (LAN) adapter, or the like.

The recording medium I/F 204 controls reading/writing of data from/to the recording medium 205 under the control of the CPU 201. The recording medium I/F 204 is, for example, a disk drive, a solid state drive (SSD), a Universal Serial Bus (USB) port, or the like. The recording medium 205 is a nonvolatile memory that stores the data written under the control of the recording medium I/F 204. The recording medium 205 is, for example, a disk, a semiconductor memory, a USB memory, or the like. The recording medium 205 may be detachable from the action determining apparatus 100. Instead of the memory 202, the recording medium 205 may store the coefficient array W which will be described later in FIG. 3 and the history table 400 which will be described later in FIG. 4.

In addition to the above-described components, the action determining apparatus 100 may include, for example, a keyboard, a mouse, a display, a speaker, a microphone, a printer, a scanner, and the like. The action determining apparatus 100 may include a plurality of the recording media I/F 204 or a plurality of the recording media 205. The action determining apparatus 100 may not include the recording medium I/F 204 or the recording medium 205.

Stored Contents of Coefficient Array W

Next, the stored contents in the coefficient array W will be described with reference to FIG. 3. The coefficient array W is realized by, for example, a storage region, such as the memory 202 or the recording medium 205 of the action determining apparatus 100 illustrated in FIG. 2.

FIG. 3 is an explanatory diagram illustrating an example of the stored contents of the coefficient array W. As illustrated in FIG. 3, the coefficient array W has a coefficient field. The coefficient array W stores coefficient information by setting information in each field for each coefficient.

In the coefficient field, a coefficient that defines the state action value function is set.

Stored Contents of History Table 400

Next, the stored contents of the history table 400 will be described with reference to FIG. 4. The history table 400 is realized by using, for example, a storage region, such as the memory 202 or the recording medium 205, in the action determining apparatus 100 illustrated in FIG. 2.

FIG. 4 is an explanatory diagram illustrating an example of the stored contents of the history table 400. As illustrated in FIG. 4, the history table 400 includes fields of the state, the action, and the gain in association with a time point field. The history table 400 stores history information by setting information in each field for each time point.

In the time point field, time points at predetermined time intervals are set. In the state field, the states of the control target 110 at the time points are set. In the action field, the actions on the control target 110 at the time points are set. In the gain field, the gains that correspond to the actions for the control target 110 at the time points are set.

Functional Configuration Example of Action Determining Apparatus 100

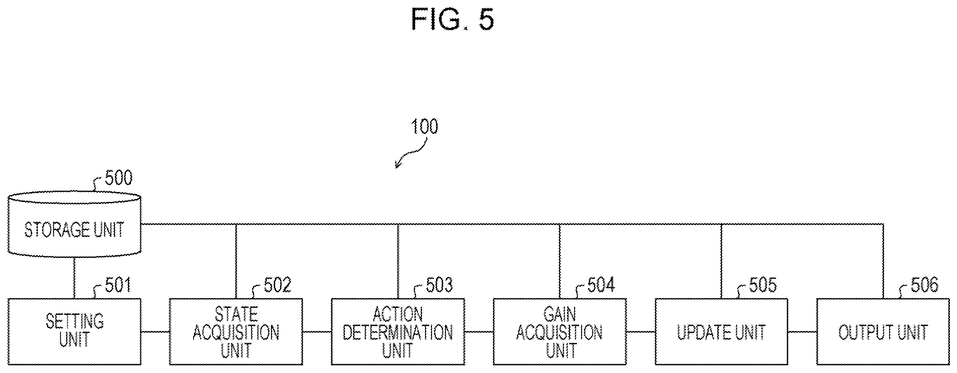

Next, a functional configuration example of the action determining apparatus 100 will be described with reference to FIG. 5.

FIG. 5 is a block diagram illustrating a functional configuration example of the action determining apparatus 100. The action determining apparatus 100 includes a storage unit 500, a setting unit 501, a state acquisition unit 502, an action determination unit 503, a gain acquisition unit 504, an update unit 505, and an output unit 506.

The storage unit 500 is realized by using, for example, a storage region, such as the memory 202 or the recording medium 205 illustrated in FIG. 2. Hereinafter, a case where the storage unit 500 is included in the action determining apparatus 100 will be described, but the embodiment is not limited thereto. For example, there may be a case where the storage unit 500 is included in an apparatus different from the action determining apparatus 100 and the action determining apparatus 100 is capable of referring to the stored contents of the storage unit 500.

Units from the setting unit 501 to the output unit 506 provide functions of a control unit. Specifically, the functions of the units from the setting unit 501 to the output unit 506 are realized by, for example, causing the CPU 201 to execute a program stored in the storage region, such as the memory 202 or the recording medium 205 illustrated in FIG. 2, or by using the network I/F 203. Results of processing performed by each functional unit are stored, for example, in the storage region, such as the memory 202 or the recording medium 205 illustrated in FIG. 2.

The storage unit 500 stores the action, the state, and the gain of the control target 110. The storage unit 500 stores, for example, the action, the state, and the gain of the control target 110 using the history table 400 illustrated in FIG. 4. Accordingly, the storage unit 500 is capable of making each processing unit refer to the action, the state, and the gain of the control target 110.

The storage unit 500 stores the value function. The value function is a state action value function. The state action value function becomes, for example, a polynomial expression for a variable that represents the action, or a polynomial expression for a variable that represents the action when a value is substituted for a variable that represents the state. The polynomial expression for the variable that represents the action may be non-linear. The polynomial expression for the variable that represents the action may include, for example, the square of the variable that represents the action. The storage unit 500 stores, for example, the coefficient of the state action value function. Specifically, the storage unit 500 stores the coefficient array W illustrated in FIG. 3. Accordingly, the storage unit 500 is capable of making each processing unit refer to the state action value function.

The setting unit 501 initializes variables used by each processing unit. For example, the setting unit 501 initializes the coefficient of the state action value function based on an operation input of the user. For example, the setting unit 501 sets the constraint condition based on the operation input of the user. An operation example of the setting unit 501 will be described later in the example, for example. Accordingly, the setting unit 501 is capable of making it possible to use the state action value function at a time point when the update unit 505 has not yet estimated the coefficient of the state action value function. In addition, the setting unit 501 is capable of causing each processing unit to refer to the constraint condition.

The state acquisition unit 502 acquires an input value related to the state. For example, the action determining apparatus 100 observes a value that indicates the state of the control target 110 at predetermined time intervals, acquires the value as an input value related to the state, and stores the acquired input value in the storage unit 500 in association with the observed time point. An operation example of the state acquisition unit 502 will be described later in the example, for example. Accordingly, the state acquisition unit 502 is capable of causing the action determination unit 503 or the update unit 505 to refer to the input value related to the state.

The action determination unit 503 obtains the optimum action related to the state action value function by using the QE. The optimum action is an action determined to be optimum based on the current state action value function. For example, the optimum action is an action that makes the state action value function as an optimum value. The optimum value is, for example, the maximum value.

The action determination unit 503 obtains the optimum action related to the state action value function using the coefficient initialized by the setting unit 501 or the coefficient estimated by the update unit 505, for example, by using the QE. The optimum action is an action that makes the state action value function an optimum value. Specifically, the action determination unit 503 obtains the optimum action related to the state action value function using the coefficient estimated by the update unit 505 based on the input value related to the state, the input value related to the action, and the gain that corresponds to the input value, which are acquired up to a predetermined timing.

More specifically, the action determination unit 503 specifies a possible range of the value of the state action value function by using the QE for the logical expression including the state action value function based on the acquired input value related to the state and the input value related to the action. Next, the action determination unit 503 obtains the optimum value of the state action value function by using the QE for the logical expression including the specified range. The action determination unit 503 obtains the optimum action related to the state action value function by using the QE for the logical expression including the obtained optimum value.

The action determination unit 503 may obtain the optimum action by using an optimization solver. For example, in a case where the state action value function is linear with respect to the action, the action determination unit 503 may obtain the optimum action by using calculation software of a linear programming problem. For example, in a case where the state action value function is convex, the action determination unit 503 may obtain the optimum action by using calculation software of a steepest gradient method. The action determination unit 503 may obtain the optimum action by differentiation when the variable of the action is one.

Further, the action determination unit 503 may obtain the optimum action related to the state action value function using the coefficient estimated by the update unit 505, to which the constraint condition is applied, by using the QE. The constraint condition is, for example, a conditional expression that represents a possible range of the action. Accordingly, the action determination unit 503 is capable of determining a preferable action on the control target 110, which satisfies the constraint condition and efficiently controlling the control target 110.

Thereafter, the action determination unit 503 determines the next action on the control target 110 based on the obtained optimum action. The action determination unit 503 specifies the action range by using the QE for the logical expression including the conditional expression that represents that the difference between the value of the state action value function and the value of the state action value function that corresponds to the optimum action is smaller than a threshold value, and determines the next action from the specified range. The logical expression is, for example, an expression (5) which will be described later. Specifically, by using the QE, the action determination unit 503 transforms the logical expression including the conditional expression that represents that the difference between the value of the state action value function and the value of the state action value function that corresponds to the optimum action is smaller than a threshold value into a logical expression including the variable that represents the action, and specifies the range of the variable that represents the action.

Specifically, the action determination unit 503 randomly selects the action, and determines the selected action as the next action when the selected action is within the specified range. Accordingly, the action determination unit 503 is capable of determining a preferable action on the control target 110, stopping a disadvantage of the control target 110, and efficiently controlling the control target 110.

Specifically, the action determination unit 503 may determine the next action by using the QE for the specified range. Accordingly, the action determination unit 503 is capable of determining the next action regardless of the size of the specified range, and reducing the processing amount required when determining the next action even when the specified range becomes smaller.

The logical expression including the conditional expression that represents that the difference between the value of the state action value function and the value of the state action value function that corresponds to the optimum action is smaller than the threshold value, may further include a conditional expression that represents the possible range of the action. The logical expression is, for example, an expression (6) or an expression (8) which will be described later. Accordingly, the action determination unit 503 is capable of determining a preferable action on the control target 110, which satisfies the constraint condition and efficiently controlling the control target 110.

The logical expression including the conditional expression that represents that the difference between the value of the state action value function and the value of the state action value function that corresponds to the optimum action is smaller than the threshold value, may further include the conditional expression that represents that the Euclidean distance between the selected action and the optimum action is larger than the threshold value. The logical expression is, for example, an expression (7) which will be described later. Accordingly, the action determination unit 503 is capable of determining a preferable next action on the control target 110 that is more than a certain distance away from the optimum action determined to be currently optimum, and accurately estimating the state action value function.

Further, the action determination unit 503 may determine the obtained optimum action as the next action on the control target 110. For example, the action determination unit 503 may determine the obtained optimum action as the next action on the control target 110 with a certain probability. For example, the action determination unit 503 may determine the obtained optimum action as the next action on the control target 110 after determining the next action by specifying the action range a certain number of times. Accordingly, the action determination unit 503 is capable of determining a preferable action on the control target 110, and efficiently controlling the control target 110.

The action determination unit 503 stores the input value related to the action in the storage unit 500. For example, the action determination unit 503 stores a value that indicates the determined next action in the storage unit 500 as an input value related to the action. An operation example of the action determination unit 503 will be described later in the example, for example. Accordingly, the action determination unit 503 is capable of referring to the next action on the control target 110 when determining the next action on the control target 110.

The gain acquisition unit 504 acquires the gain that corresponds to the input value related to the action. The gain is, for example, a reward. The gain is, for example, a value obtained by multiplying the cost by a negative value, and may be a value that makes it possible to be treated as a reward. The gain acquisition unit 504 acquires the gain in the control target 110 after a predetermined period of time after the action is performed every time the action on the control target 110 is performed. An operation example of the gain acquisition unit 504 will be described later in the example, for example. Accordingly, the gain acquisition unit 504 is capable of making the update unit 505 refer to the gain.

The update unit 505 estimates the coefficient of the state action value function based on the acquired input value related to the state, the input value related to the action, and the gain. The update unit 505 estimates the coefficient of the state action value function without using the QE in a case where the optimization problem is not included in the mathematical expression for estimating the coefficient of the state action value function. Mathematical expressions that do not include the optimization problem are capable of referring to, for example, state-action-reward-state-action (SARSA). Accordingly, the update unit 505 is capable of estimating the coefficient of the state action value function, and accurately estimating the state action value function.

The update unit 505 estimates the coefficient of the state action value function by using the QE based on the acquired input value related to the state, the input value related to the action, and the gain. The update unit 505 estimates the coefficient of the state action value function by using the QE in a case where the optimization problem is included in the mathematical expression for estimating the coefficient of the state action value function.

Specifically, there is a case where the update unit 505 uses Q learning. In this case, the update unit 505 specifies a possible range of the value of the state action value function by using the QE for the logical expression including the state action value function based on the acquired input value related to the state and the input value related to the action. Next, the update unit 505 obtains the optimum value of the state action value function by using the QE for the logical expression including the specified range. The update unit 505 estimates the coefficient of the state action value function by using the obtained optimum value based on the acquired input value related to the state, the input value related to the action, and the gain.

Specifically, there is a case where the update unit 505 uses, for example, SARSA other than Q learning. In this case, the update unit 505 does not obtain the optimum value of the state action value function, and estimates the coefficient of the state action value function. An operation example of the update unit 505 will be described later in the example, for example. Accordingly, in a case of using the Q learning, the update unit 505 is capable of estimating the coefficient of the state action value function, and accurately estimating the state action value function.

The output unit 506 outputs the action determined by the action determination unit 503 to the control target 110. Accordingly, the output unit 506 is capable of controlling the control target 110.

The output unit 506 may output the processing result of each processing unit. Examples of the output format include, for example, display on a display, printing output to a printer, transmission to an external device by a network I/F 203, and storing in a storage region, such as the memory 202 or the recording medium 205. Accordingly, the output unit 506 is capable of notifying the user of the processing result of each functional unit, and supporting management or operation of the action determining apparatus 100, for example, update of set values of the action determining apparatus 100, and improving convenience of the action determining apparatus 100.

Flow of Reinforcement Learning in Example

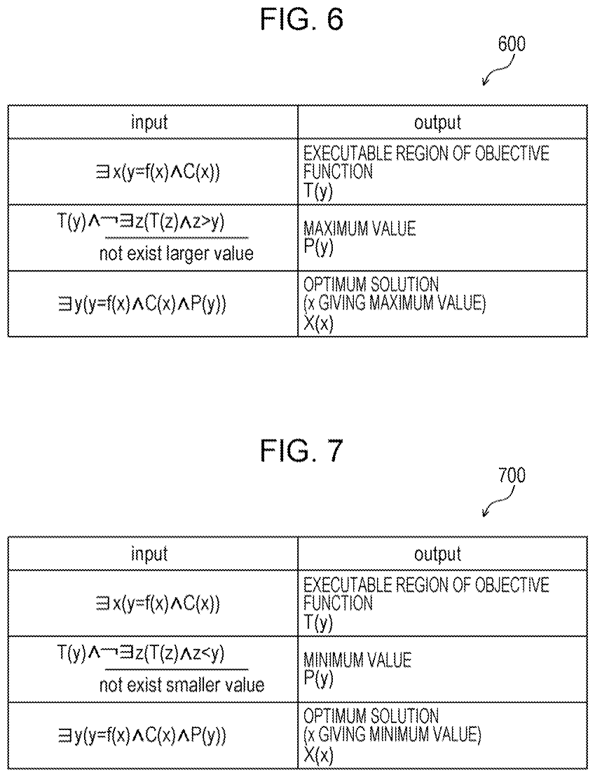

Next, a flow of the reinforcement learning in the example will be described using FIGS. 6 to 10.

FIGS. 6 to 10 are explanatory diagrams illustrating the flow of the reinforcement learning in the example. In the example of FIG. 6, a case where the action determining apparatus 100 obtains the optimum action so as to maximize the state action value function will be described. In this case, as illustrated in table 600, the action determining apparatus 100 obtains the optimum action related to the state action value function by using the QE so as to output the right logical expression when the left logical expression is input.

The QE is to convert a logical expression described by using a quantifier into a logical expression that does not use a quantifier. The quantifier is a universal quantifier (∀) and an existential quantifier (∃). The universal quantifier (∀) is a symbol that targets a variable and modifies such that a logical expression is established even in a case where the variable is any value. The existential quantifier (∃) is a symbol that targets a variable and modifies such that one or more values of the variables by which the logical expression is established exist. Regarding the QE, it is possible to refer to, for example, Reference Literatures 1 to 3 in the following.
Reference Literature 1: Basu, Saugata. Richard Pollack, and Marie-Francoise Roy. “Algorithms in real algebraic geometry.” Vol. 20033. Springer, 1996.
Reference Literature 2: Caviness, Bob F., and Jeremy R. Johnson, eds. “Quantifier elimination and cylindrical algebraic decomposition.” Springer Science & Business Media, 2012.
Reference Literature 3: Hitoshi Yanami, “Multi-objective design based on symbolic computation and its application to hard disk slider design.” JMI2009B-8—Journal of Math-for-Industry.

The first row of the table 600 illustrates that a logical expression including a function y=f(x) and a constraint condition C(x) is convertible into a logical expression illustrating an executable region T(y) of the function y=f(x), by the QE. The executable region T(y) is a possible range of the function y=f(x). The second row of the table 600 illustrates that a logical expression including the condition that there is no z greater than y, including the executable region T(y) is convertible into a logical expression illustrating the maximum value P(y) of the function y=f(x), by the QE.

The third row of the table 600 illustrates that a logical expression including the function y=f(x), the constraint condition C(x), and the maximum value P(y) of the function y=f(x) is convertible into a logical expression illustrating an optimum solution X(x) of the function y=f(x), by the QE. The optimum solution is a solution that makes it possible to make the function y=f(x) the maximum value P(y).

The action determining apparatus 100 applies the QE as illustrated in the table 600 to the state action value function. For example, the action determining apparatus 100 replaces the function f(x) in the table 600 with the following expression (1) that indicates the state action value function. Here, Q(s, a) is a state action value function. s is a state. a is an action. wᵢ is a coefficient. wᵢ is stored by the coefficient array W. wᵢϕᵢ(s, a) is a term including a variable that represents a state and an action with a coefficient. ϕᵢ(s, a) is a term for expressing the state action value function so as to become a polynomial expression with respect to a result a after substituting a value for s with a monomial of degree 2 or less of s and a.

Q(s,a)=Σwᵢϕᵢ(s,a) (1)

Accordingly, the action determining apparatus 100 is capable of obtaining a logical expression that is equivalent to the logical expression including the above-described expression (1) that indicates the state action value function, does not include the quantifier, and does not include the action a, and is capable of obtaining the optimum action or the optimum value of the above-described expression (1) that indicates the state action value function. Therefore, the action determining apparatus 100 is capable of realizing the reinforcement learning in a case where the action a is a continuous quantity.

Furthermore, since the action determining apparatus 100 is capable of obtaining the optimum value of the above-described expression (1) that indicates the state action value function, for example, in a case of using the Q learning as the reinforcement learning method, by using the following expression (2), it is possible to update the coefficient wᵢ of the above-described expression (1) that indicates the state action value function, and to estimate the state action value function. For example, the action determining apparatus 100 is capable of substituting the optimum value of the above-described expression (1) that indicates the state action value function for the underlined portion of the following expression (2). Here, t is a time point. sₜ is a state at time point t. aₜ is an action at time point t. rₜ is a gain for the action aₜ time point t.

$${w}_{i} ← {w}_{i} + α \frac{\partial Q ( {s}_{t} , {a}_{t} )}{\partial {w}_{i}} ( {r}_{t} + \underline{γ {max}_{α} Q ( {s}_{t + 1} , a )} - Q ( {s}_{t} , {a}_{t} ) ) \qquad ( 2 )$$

Furthermore, the action determining apparatus 100 is capable of using the constraint condition C(s, a). The action determining apparatus 100 is capable of realizing the reinforcement learning in consideration of the constraint conditions for action by using, for example, the following expression (3) and the following expression (4) as the constraint condition C(s, a). In the following expression (3) and the following expression (4), a₁ and a₂ are variables included in a plurality of variables a₁, a₁, . . . , and aₙ that represent the action a at a certain time point.

0≤a₁≤1∧1≤a₂≤3 (3)

a₁=0∨a₂=0 (4)

Accordingly, in the action determining apparatus 100, it is possible to use the constraint condition in the reinforcement learning, and to control the control target 110 by accurately considering the properties of the control target 110. Therefore, in the action determining apparatus 100, it is possible to apply the reinforcement learning to various types of control targets 110, and to improve the convenience of the reinforcement learning. Specific examples of making it possible to use the constraint condition will be described later in the example. Next, the description continues with reference to FIG. 7.

In the example of FIG. 6, a case where the action determining apparatus 100 obtains the optimum action so as to maximize the state action value function has been described. In contrast, in the example of FIG. 7, a case where the action determining apparatus 100 obtains the optimum action so as to minimize the state action value function will be described. In this case, as illustrated in a table 700, the action determining apparatus 100 obtains the optimum action related to the state action value function by using the QE so as to output the right logical expression when the left logical expression is input.

Here, since the first row of the table 700 is the same as the first row of the table 600, the description thereof will be omitted. The second row of the table 700 illustrates that a logical expression including the condition that there is no z smaller than y, including the executable region T(y) is convertible into a logical expression illustrating the minimum value P(y) of the function y=f(x), by the QE.

The third row of the table 700 illustrates that a logical expression including the function y=f(x), the constraint condition C(x), and the minimum value P(y) of the function y=f(x) is convertible into a logical expression illustrating the optimum solution X(x) of the function y=f(x), by the QE. The optimum solution is a solution that makes it possible to make the function y=f(x) the minimum value P(y).

The action determining apparatus 100 applies the QE as illustrated in the table 700 to the state action value function. Since a specific example of applying the QE illustrated in the table 700 to the state action value function is the same as the specific example of applying the QE as illustrated in the table 600 to the state action value function, the description thereof will be omitted.

The action determining apparatus 100 may express the state action value function by a polynomial expression for both the variable that represents the state and the variable that represents the action. In this case, when the mathematical expression for obtaining the optimum action related to the state action value function by the QE is obtained in advance, the action determining apparatus 100 may not use the QE every time the optimum action related to the state action value function is obtained, and it is possible to reduce the processing amount. Specifically, it is possible to obtain the mathematical expression for obtaining the optimum action by the following expressions (11) to (13).

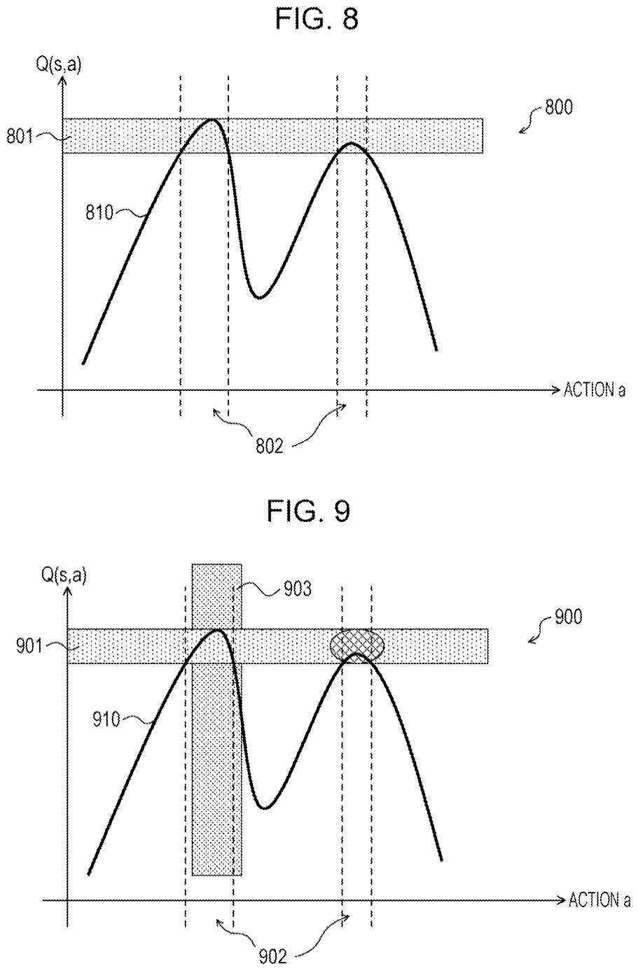

Here, a case where the action determining apparatus 100 obtains the optimum action by using the QE has been described, but the embodiment is not limited thereto. For example, there is a case where the action determining apparatus 100 obtains the optimum action by using the optimization solver. Next, the description continues with reference to FIG. 8.

In the example of FIG. 8, a case where the action determining apparatus 100 specifies a range for determining a search action based on the obtained optimum action will be described. The search action is an action for trying to estimate the state action value function. The search action may not be the optimum action. In this case, the action determining apparatus 100 specifies an action range 802 that corresponds to a range 801 of the state action value function illustrated in a table 800 as a range for determining the search action by using the QE.

The horizontal axis in the table 800 is an action. The vertical axis in the table 800 is a value of the state action value function. The value of the state action value function for the action exists over a curve 810. The range 801 is a range of the state action value function in which the difference between the value of the state action value function and the optimum value of the state action value function is smaller than the threshold value.

Specifically, the action determining apparatus 100 applies the QE to the following expression (5) that represents the range 801. Here, Q(s, a) is a state action value function. s is a state. a=aᵢ, . . . , and aₙ is an action. aₜ*=a₁*, . . . , and aₙ* is an optimum action. u is a threshold value.

∃y(y=Q(s,a₁, . . . ,aₙ)∧Q(s,a₁*, . . . ,aₙ*)−y<u) (5)

Accordingly, the action determining apparatus 100 is equivalent to the logical expression of the above-described expression (5) that represents the range 801, and is capable of obtaining the logical expression ψ(a₁, . . . , aₙ) that does not include the quantifier and does not include the variable y. The logical expression ψ(a₁, . . . , aₙ) is a logical expression that represents the range of the action a=a₁, . . . , aₙ. Regarding the applicability of the QE to the first-order predicate logical expression, such as the above-described expression (5), for example, it is possible to refer to the above-described Reference Literatures 1 to 3.

Therefore, in order to keep the value of the state action value function that corresponds to the search action within the range from the optimum value of the state action value function to a threshold value u, the action determining apparatus 100 is capable of determining from which range the search action may be selected. As a result, the action determining apparatus 100 is capable of stopping the search action from becoming an action having a value lower than a certain value compared to the optimum action.

Furthermore, the action determining apparatus 100 is capable of using the constraint condition C(s, a). For example, the action determining apparatus 100 is capable of obtaining the logical expression ψ(a₁, . . . , aₙ) that represents the range for determining the action a=a₁, . . . , aₙ in consideration of the constraint condition C(s, a) for the action by using the logical expression of the following expression (6) instead of the logical expression of the above-described expression (5). Regarding the applicability of the QE to the first-order predicate logical expression, such as the above-described expression (6), for example, it is possible to refer to the above-described Reference Literatures 1 to 3. The constraint condition C(s, a) is a condition that represents the possible range of the action a by using the state s and the action a.

∃y(y=Q(s,a₁, . . . ,aₙ)∧C(s,a)∧Q(s,a₁*, . . . ,aₙ*)−y<u) (6)

Accordingly, in the action determining apparatus 100, it is possible to use the constraint condition in the reinforcement learning, and to obtain the logical expression that represents the range for determining the action a=a₁, . . . , aₙ by accurately considering the properties of the control target 110. Therefore, in the action determining apparatus 100, it is possible to apply the reinforcement learning to various types of control targets 110, and to improve the convenience of the reinforcement learning. Specific examples of making it possible to use the constraint condition will be described later in the example. Next, the description continues with reference to FIG. 9.

In the example of FIG. 9, a case where the action determining apparatus 100 specifies the range for determining the search action that is more than a certain distance away from the obtained optimum action has been described. In this case, the action determining apparatus 100 specifies an action range except for an action range 903 from an action range 902 that corresponds to a range 901 of the state action value function illustrated in a table 900 as a range for determining the search action, by using the QE.

The horizontal axis in the table 900 is an action. The vertical axis in the table 900 is a value of the state action value function. The value of the state action value function for the action exists over a curve 910. The range 901 is a range of the state action value function in which the difference between the value of the state action value function and the optimum value of the state action value function is smaller than the threshold value. The range 903 is an action range in which the Euclidean distance between the action and the optimum action is equal to or less than the threshold value.

Specifically, the action determining apparatus 100 applies the QE to the following expression (7) including a conditional expression that represents the range 901 and a conditional expression that represents a range other than the range 903. Here, Q(s, a) is a state action value function. s is a state. a=a₁, . . . , and aₙ is an action. aₜ*=a₁*, . . . , and aₙ* is an optimum action. u is a threshold value for the value of the state action value function. r is a threshold value regarding the distance between actions.

∃y(((a₁−a₁*)²+ . . . +(aₙ−aₙ*)²)>r²∧y=Q(s,a₁, . . . ,aₙ)∧Q(s,a₁*, . . . ,aₙ*)−y<u) (7)

Accordingly, the action determining apparatus 100 is equivalent to the logical expression of the above-described expression (7), and is capable of obtaining the logical expression ψ(a₁, . . . , aₙ) that does not include the quantifier and does not include the variable y. The logical expression ψ(a₁, . . . , aₙ) is a logical expression that represents the range of the action a=a₁, . . . , aₙ. Regarding the applicability of the QE to the first-order predicate logical expression, such as the above-described expression (7), for example, it is possible to refer to the above-described Reference Literatures 1 to 3.

Therefore, in order to keep the value of the state action value function that corresponds to the search action within the range from the optimum value of the state action value function to a threshold value u, the action determining apparatus 100 is capable of determining from which range the search action may be selected. As a result, the action determining apparatus 100 is capable of stopping the search action from becoming an action having a value lower than a certain value compared to the optimum action.

In addition, the action determining apparatus 100 is capable of determining a preferable search action on the control target 110 that is more than a certain distance away from the optimum action determined to be currently optimum. Therefore, in a case where an action which is more appropriate than the optimum action determined to be currently optimum exists at a position away from the optimum action determined to be currently optimum, the action determining apparatus 100 is capable of trying the action and reflecting the value of the action to the state action value function. As a result, the action determining apparatus 100 is capable of accurately estimating the state action value function.

Furthermore, the action determining apparatus 100 is capable of using the constraint condition C(s, a). For example, the action determining apparatus 100 is capable of obtaining the logical expression ψ(a₁, . . . , aₙ) that represents the possible range of the action a=a₁, . . . , aₙ in consideration of the constraint condition C(s, a) for the action by using the logical expression of the following expression (8) instead of the logical expression of the above-described expression (7). Regarding the applicability of the QE to the first-order predicate logical expression, such as the above-described expression (8), for example, it is possible to refer to the above-described Reference Literatures 1 to 3. The constraint condition C(s, a) is a condition that represents the possible range of the action a by using the state s and the action a.

∃y(((a₁−a₁*)²+ . . . +(aₙ−aₙ*)²)>r²∧y=Q(s,a₁, . . . ,aₙ)∧C(s,a)∧Q(s,a₁*, . . . ,aₙ*)−y<u) (8)

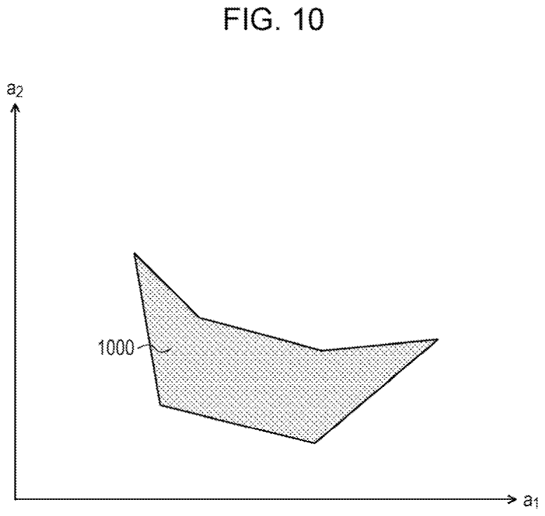

Accordingly, in the action determining apparatus 100, it is possible to use the constraint condition in the reinforcement learning, and to obtain the logical expression that represents the possible range of the action a=a₁, . . . , aₙ by accurately considering the properties of the control target 110. Therefore, in the action determining apparatus 100, it is possible to apply the reinforcement learning to various types of control targets 110, and to improve the convenience of the reinforcement learning. Specific examples of making it possible to use the constraint condition will be described later in the example. Next, the description continues with reference to FIG. 10.

In the example of FIG. 10, a case where the action determining apparatus 100 determines the search action from the logical expression ψ(a₁, . . . , aₙ) that represents the specified action range has been described. In the example of FIG. 10, the action range represented by the logical expression ψ(a₁, . . . , aₙ) is a range 1000. The action range represented by the logical expression ψ(a₁, . . . , aₙ) may be a set of two or more divided ranges.

In this case, the action determining apparatus 100 randomly selects the action that satisfies the logical expression ψ(a₁, . . . , aₙ) that represents the specified action range, and determines the selected action as the search action. Accordingly, the action determining apparatus 100 is capable of keeping the value of the state action value function that corresponds to the search action within the range from the optimum value of the state action value function to the threshold value u, and stopping the action having a relatively low value from being determined as the search action.

In addition, the action determining apparatus 100 may determine the search action by applying the QE to the logical expression ψ(a₁, . . . , aₙ) that represents the specified action range. Accordingly, the action determining apparatus 100 is capable of reducing the processing amount required when determining a search regardless of the size of the specified action range. Specific examples for determining the search action will be described later in the example.

Specific Example of Reinforcement Learning in Example

Next, a specific example of the reinforcement learning in the example will be described. Here, in the example, a specific example of the reinforcement learning in which the action determining apparatus 100 determines the search action aₜ based on the optimum action aₜ* and controls the control target 110 will be described.

In the example, the setting unit 501 sets ϕᵢ(s, a) that defines the state action value function in the above-described expression (1). For example, the setting unit 501 sets, for example, ϕᵢ(s, a) based on the operation input of the user. Specifically, the setting unit 501 sets ϕᵢ(s, a) as a polynomial expression for a as illustrated in the following expression (9). d_{i,j} is defined by the following expression (10).

$$\begin{matrix}{φ}_{i} ( s , a ) = {\sum }_{j} {ψ}_{j} ( s ) {a}_{1}^{{d}_{1 , j}} … {a}_{m}^{{d}_{m , j}} & ( 9 ) \\ {d}_{i , j} ∈ {ℤ}_{\geq 0} & ( 10 )\end{matrix}$$

For example, there is a case where the setting unit 501 sets ϕᵢ(s, a) with a monomial of degree 2 or less of s and a. In this case, for example, “ϕ₁=1, ϕ₂=s₁, ϕ₃=s₂, . . . , ϕₙ₊₂=a₁, . . . ” are set.

For example, there is a case where the setting unit 501 sets ϕᵢ(s, a) so as to obtain a polynomial expression for a as a result of substituting a value for s. In this case, for example, “ϕ₁=1, ϕ₂=exp(s₁), . . . , ϕₙ₊₂=a₁*exp(s₂), . . . ” are set. Accordingly, the setting unit 501 is capable of expressing the state action value function by a polynomial expression, using the state action value function, and treating the action as a continuous quantity using a polynomial expression.

The setting unit 501 sets the constraint condition C(s, a). For example, the setting unit 501 sets, for example, the constraint condition C(s, a) based on the operation input of the user. The constraint condition C(s, a) is defined in the form of a first-order predicate logical expression regarding s and a, for example. The constraint condition C(s, a) is defined as a polynomial expression for a. Accordingly, the setting unit 501 is capable of using the constraint condition in the reinforcement learning, and controlling the control target 110 by accurately considering the properties of the control target 110.

The setting unit 501 initializes the coefficient array W. For example, the setting unit 501 initializes the coefficient wᵢ which is an element of the coefficient array W with a random value in a range of −1 to 1. The setting unit 501 may initialize the coefficient wᵢ, which is an element of the coefficient array W, with a model related to the control target 110 based on the operation input of the user.

The setting unit 501 initializes a variable t that indicates a time point. For example, the setting unit 501 sets a variable t=0 that indicates a time point. The variable t is, for example, a variable that indicates a time point for each unit time. The variable t is, for example, a variable that is incremented every time the unit time elapses.

Thereafter, the state acquisition unit 502, the action determination unit 503, the gain acquisition unit 504, and the update unit 505 repeat processing as described below.

In the example, the state acquisition unit 502 observes the state sₜ of the control target 110 at time point t for each unit time and stores the observed state sₜ by using the history table 400.

In the example, the action determination unit 503 reads the state sₜ of the control target 110 at time point t from the history table 400 for each unit time and determines the action for the control target 110. The action determination unit 503 determines the optimum action aₜ* that maximizes the state action value function Q(sₜ, a) by using, for example, the QE, and determines the search action aₜ based on the optimum action aₜ*.

First, specifically, the action determination unit 503 applies the QE to the logical expression on the right side of the following expression (11), and specifies a possible range T(F) of the value of the state action value function Q(sₜ, a) illustrated on the left side of the following expression (11). The state action value function Q(sₜ, a) is expressed by a polynomial expression for a because it is possible to substitute sₜ as sₜ. The following expression (11) corresponds to the first row of the table 600.

T(F)≡∃a₁ . . . ∃aₘ(F=Q(sₜ,a)∧C(sₜ,a)) (11)

Next, the action determination unit 503 applies the QE to the logical expression on the right side of the following expression (12) including the range T(F), and specifies the maximum value T*(F*) of the state action value function Q(sₜ, a) illustrated on the left side of the following expression (12). The superscript * is a symbol that indicates the maximum value. The following expression (12) corresponds to the second row of the table 600.

T*(F*)≡∀F(T(F)→F*≥F∧T(F*)) (12)

The action determination unit 503 applies the QE to the logical expression on the right side of the following expression (13) including the maximum value T*(F*), and specifies the optimum action aₜ*=T*ₐ(a) that makes it possible to make the state action value function Q(sₜ, a) illustrated on the left side of the following expression (13) as the maximum value T*(F*). The superscript * is a symbol that indicates the optimum action. The following expression (13) corresponds to the third row of the table 600.

T*ₐ(a)≡∃F*(F*=Q(sₜ,a)∧C(sₜ,a)∧T*(F*)) (13)

There may be a case where the action determination unit 503 does not use the QE when determining the optimum action aₜ*. For example, in a case where the state action value function is linear with respect to the action, the action determination unit 503 may determine the optimum action aₜ* by using calculation software of a linear programming problem. For example, in a case where the state action value function is convex, the action determination unit 503 may determine the optimum action aₜ* by using calculation software of a steepest gradient method.

The action determination unit 503 determines the search action aₜ based on the optimum action aₜ*=T*ₐ(a) and sets the determined search action aₜ as the next action on the control target 110. The action determination unit 503 may commonly determine the search action aₜ, may determine the search action aₜ with a certain probability, or may determine the search action aₜ every certain number of times. In a case where the action determination unit 503 does not determine the search action aₜ, the action determination unit 503 sets the optimum action aₜ* as the next action on the control target 110.

For example, the action determination unit 503 applies the QE to the following equation (14) and obtains the logical expression ψ(a₁, . . . , aₙ) that does not include the variable y. Here, Q(s, a) is a state action value function. s is a state. a=a₁, . . . , and aₙ is an action. aₜ*=a₁*, . . . , and aₙ* is an optimum action. u is a threshold value. The logical expression ψ(a₁, . . . , aₙ) is a logical expression that represents the range of the search action aₜ=a₁, . . . , aₙ.

∃y(y=Q(s,a₁, . . . aₙ)∧Q(s,a₁*, . . . aₙ*)−y<u) (14)

Similarly, the action determination unit 503 may apply the QE to the following equation (15) and obtain the logical expression ψ(a₁, . . . , aₙ) that does not include the variable y. The constraint condition C(s, a) is a condition that represents the possible range of the action.

∃y(y=Q(s,a₁, . . . aₙ)∧C(s,a)∧Q(s,a₁*, . . . aₙ*)−y<u) (15)

Similarly, the action determination unit 503 may apply the QE to the following equation (16) and obtain the logical expression ψ(a₁, . . . , aₙ) that does not include the variable y. Here, Q(s, a) is a state action value function. s is a state. a=a₁, . . . , and aₙ is an action. aₜ*=a₁*, . . . , and aₙ* is an optimum action. u is a threshold value for the value of the state action value function. r is a threshold value regarding the distance between actions.

∃y(((a₁−a₁*)²+ . . . +(aₙ−aₙ*)²)>r²∧y=Q(s,a₁, . . . aₙ)∧Q(s,a₁*, . . . aₙ*)−y<u) (16)

Similarly, the action determination unit 503 may apply the QE to the following equation (17) and obtain the logical expression ψ(a₁, . . . , aₙ) that does not include the variable y. The constraint condition C(s, a) is a condition that represents the possible range of the action.

∃y(((a₁−a₁*)²+ . . . +(aₙ−aₙ*)²)>r²∧y=Q(s,a₁, . . . aₙ)∧C(s,a)∧Q(s,a₁*, . . . aₙ*)−y<u) (17)

The action determination unit 503 determines the search action from the logical expression ψ(a₁, . . . , aₙ) that represents the specified action range. For example, the action determination unit 503 randomly selects the action that satisfies the logical expression ψ(a₁, . . . , aₙ) that represents the specified action range, and determines the selected action as the search action aₜ.

The action determination unit 503 may determine the search action by applying the QE to the logical expression ψ(a₁, . . . , aₙ) that represents the specified action range. Specifically, the action determination unit 503 randomly selects i from i=1, . . . , n, applies the QE to the right side of the following equation (18), and acquires the left side of the following equation (18).

φᵢ(aᵢ):=∃a₁ . . . ∃aᵢ₋₁∃aᵢ₊₁ . . . ∃aₙψ (18)

Based on the result of applying the QE, the action determination unit 503 expresses φᵢ(aᵢ) in a format of the interval sum illustrated by the following equation (19). Specifically, in the method for expressing φᵢ(aᵢ) in a format of the interval sum, it is possible to refer to the above-described Reference Literature 2.

φᵢ(aᵢ)=l₁≤aᵢ≤h₁∨ . . . ∨lₘ≤aᵢ≤hₘ (19)

The action determination unit 503 selects j from j=1, . . . , m with the probability indicated by the following expression (20).

$$\frac{{h}_{j} - {l}_{j}}{{\sum }_{k = 1}^{m} ( {h}_{k} - {l}_{k} )} \qquad ( 20 )$$

The action determination unit 503 randomly selects aᵢ from a region illustrated by the following expression (21) that corresponds to the selected j, and substitutes aᵢ for the logical expression ψ.

lⱼ≤aᵢ≤hⱼ (21)

The action determination unit 503 repeats the above-described processing and determines the search action aₜ=(a₁, . . . , aₙ).

Thereafter, the action determination unit 503 controls the control target 110 by giving the determined optimum action aₜ* or the search action aₜ to the control target 110 as the next action on the control target 110 via the output unit 506. The action determination unit 503 stores the action aₜ given to the control target 110 by using the history table 400.

Accordingly, in the action determination unit 503, in the reinforcement learning, it is possible to treat the action as a continuous quantity, to finely adjust the action, and to efficiently control the control target 110. Further, since the action determination unit 503 is capable of obtaining the maximum value of the state action value function without comprehensively calculating the value of the state action value function using all of the continuous actions, it is possible to suppress an increase in time required for the reinforcement learning.

Further, the action determination unit 503 is capable of stopping the action having a relatively low value from being determined as the next action. As a result, the action determination unit 503 is capable of efficiently controlling the control target 110 and stopping the control target 110 from being disadvantageous. For example, when the control target 110 is an unmanned air vehicle, the action determination unit 503 is capable of stopping the action on the control target 110 from becoming an action that makes a stable fly difficult, and is capable of stopping the control target 110 from falling.

The action determination unit 503 is capable of trying an action having a relatively high value rather than the action having a relatively low value, accurately estimating the range in which the value of the state action value function is close to the optimum value, and efficiently estimating the state action value function.

In the example, the gain acquisition unit 504 acquires a gain rₜ₋₁ that corresponds to the action aₜ from the control target 110 when the variable t=t+1 that indicates the time point is established after the unit time when the action aₜ is given to the control target 110. The gain rₜ₋₁ is a scalar quantity. The gain acquisition unit 504 stores the gain rₜ₋₁ by using the history table 400.

In the example, the update unit 505 updates the coefficient array W=w₁, . . . , wₙ at a predetermined timing. The predetermined timing is, for example, a timing every time the action determination unit 503 obtains the action aₜ N times and gives the action aₜ to the control target 110.

For example, in a case where the records that correspond to the time points t0, . . . , tk are stored in the history table 400 by using the Q learning as an update rule, the update unit 505 performs processing with respect to the time points t0, . . . , tk−1 by using the update rule illustrated in the following expression (22). It is possible to acquire sₜ, aₜ, sₜ₊₁, and rₜ from the history table 400.

$${w}_{i} ← {w}_{i} + α \frac{\partial Q ( {s}_{t} , {a}_{t} )}{\partial {w}_{i}} ( {r}_{t} + γ {max}_{α} Q ( {s}_{t + 1} , a ) - Q ( {s}_{t} , {a}_{t} ) ) \qquad ( 22 )$$

The update unit 505 calculates a max portion of the above-described expression (22) by using the QE. A constraint condition may be defined for the max portion. First, specifically, the update unit 505 applies the QE to the logical expression on the right side of the following expression (23), and specifies the possible range T(F) of the value of the state action value function Q(sₜ₊₁, a) illustrated on the left side of the following expression (23). The state action value function Q(sₜ₊₁, a) is expressed by a polynomial expression for a. The following expression (23) corresponds to the first row of the table 600.

T(F)≡∃a₁ . . . ∃aₘ(F=Q(sₜ₊₁,a)∧C(sₜ₊₁,a)) (23)

Next, the update unit 505 applies the QE to the logical expression on the right side of the following expression (24) including the range T(F), and specifies the maximum value T*(F*) of the state action value function Q(sₜ₊₁, a) illustrated on the left side of the following expression (24). The superscript * is a symbol that indicates the maximum value. The following expression (24) corresponds to the second row of the table 600.

T*(F*)≡∀F(T(F)→F*≥F∧T(F*)) (24)

The update unit 505 updates the coefficient array W=w₁, . . . , wₙ based on the above-described expression (22) by using the maximum value T*(F*) in the max portion of the above-described expression (22).

Accordingly, the update unit 505 is capable of updating the coefficient array W=w₁, . . . , wₙ, estimating the state action value function so as to accurately illustrate the cumulative gain of the control target 110, and efficiently controlling the control target 110. The update unit 505 deletes the record in the history table 400, leaving the last record. When the SARSA is referred to as the update rule, the update unit 505 may not calculate the max portion.

Specific Example of Control Target 110

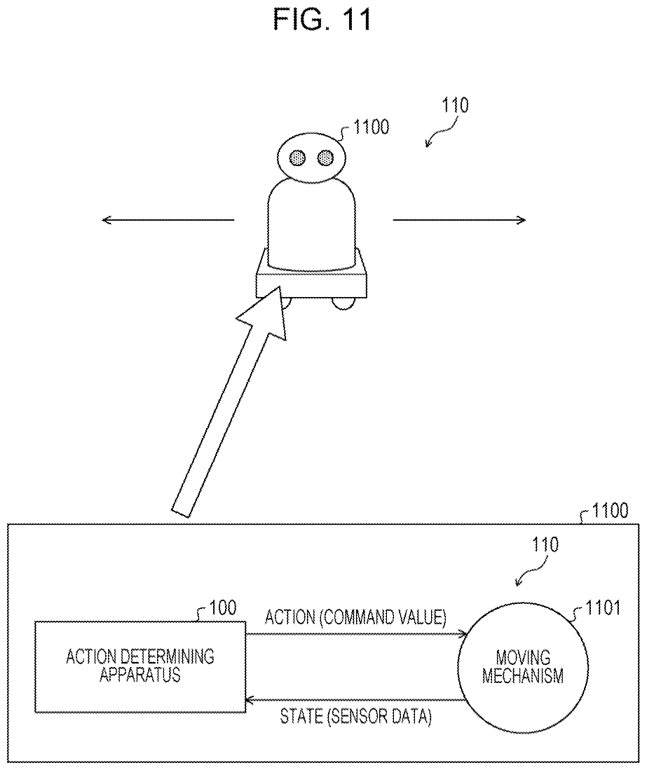

Next, a specific example of the control target 110 will be described with reference to FIGS. 11 to 13.

FIGS. 11 to 13 are explanatory diagrams illustrating specific examples of the control target 110. In the example of FIG. 11, the control target 110 is an autonomous moving object 1100, specifically, a moving mechanism 1101 of the autonomous moving object 1100. The autonomous moving object 1100 is specifically a drone, a helicopter, an autonomous mobile robot, an automobile, or the like. The action is a command value for the moving mechanism 1101. The action is, for example, a command value related to a moving direction, a moving distance, or the like. It is possible to treat the moving direction or the moving distance as a continuous quantity.

For example, when the autonomous moving object 1100 is a helicopter, the action includes the speed of a rotating blade, the gradient of a rotating surface of the rotating blade, and the like. For example, when the autonomous moving object 1100 is an automobile, the action includes the strength of an accelerator or a brake, the direction of the steering wheel, and the like.

The state is sensor data from a sensor device provided in the autonomous moving object 1100, such as the position of the autonomous moving object 1100. The gain is, for example, a value obtained by multiplying a short-term error between the target position of the autonomous mobile robot 1100 and the current position of the autonomous mobile robot 1100 by a negative value. The state action value function is, for example, a function that represents a value obtained by multiplying a long-term error between the target position of the autonomous mobile robot 1100 and the current position of the autonomous mobile robot 1100 by a negative value, as a cumulative gain.

Here, the action determining apparatus 100 is capable of stopping the command value that causes an increase in the error between the target operation of the autonomous moving object 1100 and the actual operation of the autonomous moving object 1100 from being determined as the command value that becomes the next action. Therefore, the action determining apparatus 100 is capable of stopping a disadvantage of the autonomous moving object 1100.

For example, when the autonomous moving object 1100 is a helicopter, the action determining apparatus 100 is capable of stopping the helicopter from being damaged by being out of balance and falling. For example, when the autonomous moving object 1100 is an autonomous mobile robot, the action determining apparatus 100 is capable of stopping the autonomous mobile robot from being damaged by falling out of balance or colliding with an obstacle.

The action determining apparatus 100 is capable of updating the coefficient of the state action value function so as to efficiently minimize the long-term error, determining the command value to be the next action, and controlling the moving mechanism 1101 that is the control target 110.

At this time, the action determining apparatus 100 is capable of setting a command value for the next action in fine units, and efficiently controlling the moving mechanism 1101 that is the control target 110. For example, the action determining apparatus 100 is capable of specifying the moving direction in any direction of 360 degrees, and efficiently controlling the moving mechanism 1101 that is the control target 110. Controlling the moving mechanism 1101 may be effectuated through, for example, the transmission of a control signal to the control target 110. Therefore, the action determining apparatus 100 is capable of reducing the time required until the error is minimized, and the autonomous moving object 1100 is capable of accurately and quickly reaching the final target position.

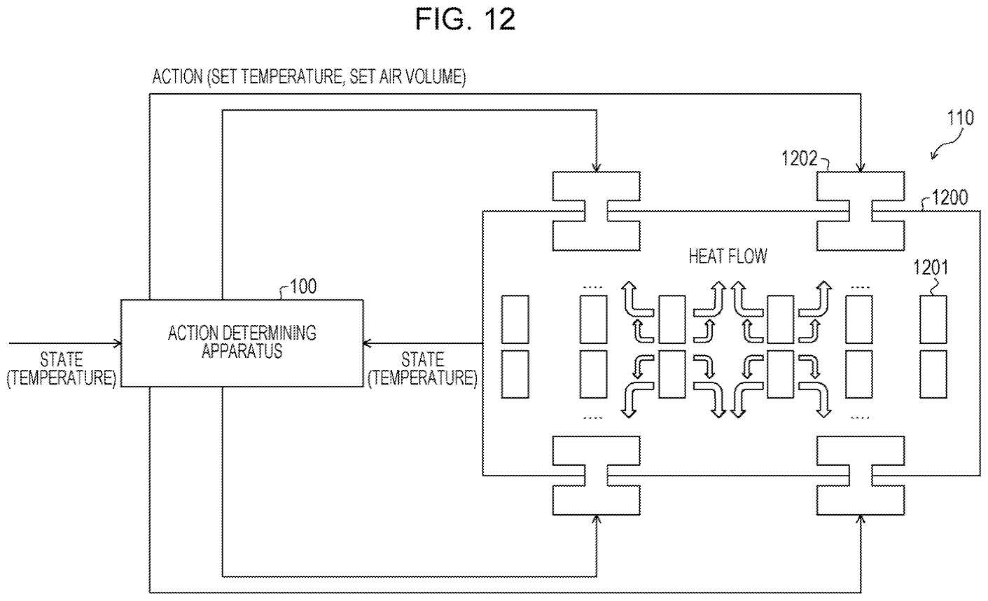

In the example of FIG. 12, the control target 110 is computer room air conditioning (CRAC) unit 1202 for a server room 1200 including a server 1201 that is a heat source. The action is a set temperature or a set air volume for the CRAC 1202.

The state is sensor data from a sensor device provided in the server room 1200, such as the temperature. The state may be data related to the control target 110 obtained from a target other than the control target 110, and may be, for example, temperature or weather. The gain is, for example, a value obtained by multiplying the power consumption for 5 minutes in the server room 1200 by a negative value. The state action value function is, for example, a function that represents a value obtained by multiplying the accumulated power consumption for 24 hours in the server room 1200 by a negative value as a cumulative gain.

Here, the action determining apparatus 100 is capable of stopping the action that largely increases the power consumption for 24 hours in the server room 1200 from being determined as the next action. Therefore, the action determining apparatus 100 is capable of stopping a disadvantage of the server room 1200. For example, even when estimating the state action value function, the action determining apparatus 100 is capable of suppressing the power consumption for 24 hours in the server room 1200 to a certain level or less.

The action determining apparatus 100 is capable of updating the state action value function so as to efficiently minimize the accumulated power consumption for 24 hours, and efficiently determining the next optimum action. At this time, the action determining apparatus 100 is capable of setting the set temperature and the set air volume, which are the next actions, in fine units, and efficiently controlling the server room 1200 that is the control target 110. Setting the set temperature and the set air volume may be effectuated through, for example, the transmission of a control signal to the CRAC unit 1202.

Therefore, the action determining apparatus 100 is capable of reducing the time required until the accumulated power consumption of the control target 110 is minimized, and reducing the operating cost of the server room 1200. Even in a case where a change in the use status of the server 1201 or a change in temperature occurs, the action determining apparatus 100 is capable of efficiently minimizing the accumulated power consumption in a relatively short period of time from the change.

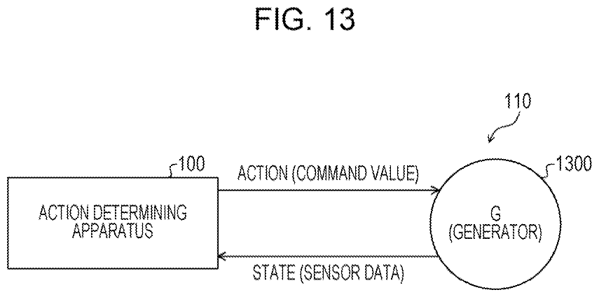

In the example of FIG. 13, the control target 110 is a generator 1300. The action is a command value for the generator 1300. The state is sensor data from a sensor device provided in the generator 1300, and is, for example, a power generation amount of the generator 1300, a rotation amount of a turbine of the generator 1300, or the like. The gain is, for example, a power generation amount for 5 minutes of the generator 1300. The state action value function is, for example, a function that represents an accumulated power generation amount for 24 hours of the generator 1300 as a cumulative gain.

Here, the action determining apparatus 100 is capable of stopping a command value that reduces the accumulated power generation amount for 24 hours of the generator 1300 from being determined as the command value that causes the next action. Therefore, the action determining apparatus 100 is capable of stopping a disadvantage of the generator 1300. For example, since a load on the turbine of the generator 1300 increases, the turbine is stopped, and the turbine is restarted, the action determining apparatus 100 is capable of stopping a situation in which the accumulated power generation amount for 24 hours of the generator 1300 decreases.

The action determining apparatus 100 is capable of updating the coefficient of the state action value function so as to efficiently maximize the accumulated power generation amount for 24 hours, determining the command value to be the next action, and controlling the generator 1300 that is the control target 110. At this time, the action determining apparatus 100 is capable of setting a command value for the next action in fine units, and efficiently controlling the generator 1300 that is the control target 110. Setting the command value may be effectuated through, for example, the transmission of a control signal to the generator 1300.

Therefore, the action determining apparatus 100 is capable of reducing the time required until the accumulated power generation amount of the control target 110 is maximized, and increasing the profit of the generator 1300. Further, even in a case where a change in the status of the generator 1300 occurs, the action determining apparatus 100 is capable of efficiently maximizing the accumulated power generation amount in a relatively short period of time from the change.

The control target 110 may be, for example, a chemical plant. The control target 110 may be, for example, a competition type game. In this case, the action determining apparatus 100 is capable of stopping the action on the control target 110 from becoming an action that makes the game situation too disadvantageous, and stopping a case where it becomes difficult to make up for the game situation thereafter. Stopping the action on the control target 110 may be effectuated through, for example, the transmission of a control signal to the control target 110.

Example of Reinforcement Learning Processing Procedure

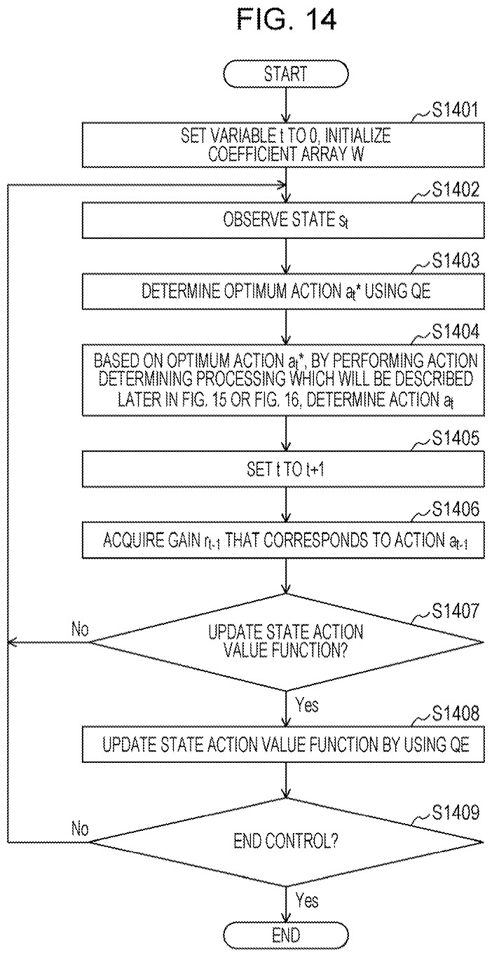

Next, an example of the reinforcement learning processing procedure will be described with reference to FIG. 14.

FIG. 14 is a flowchart illustrating an example of the reinforcement learning processing procedure. In FIG. 14, the action determining apparatus 100 sets the variable t to 0 and initializes the coefficient array W (step S1401). Next, the action determining apparatus 100 observes the state sₜ (step S1402).

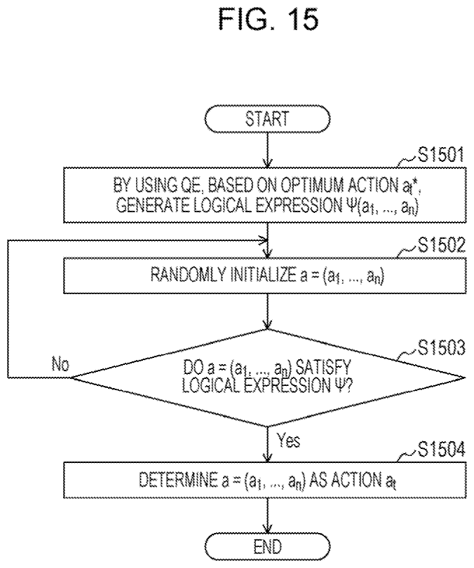

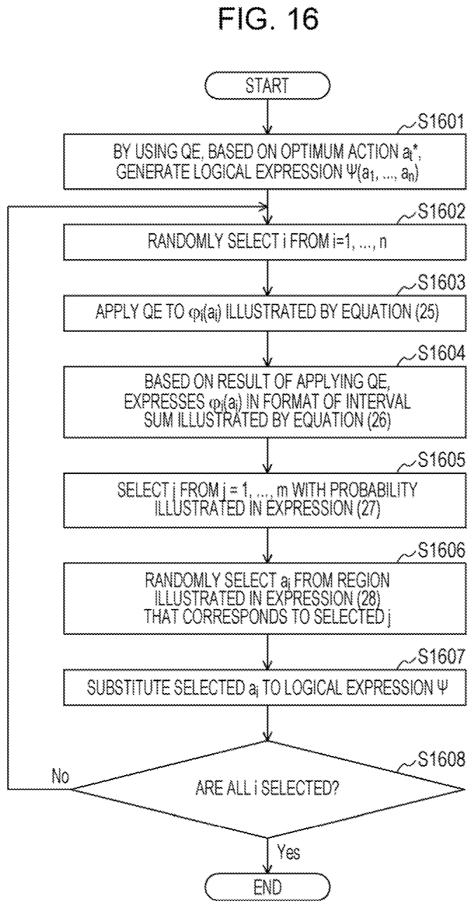

The action determining apparatus 100 determines the optimum action aₜ* that optimizes the state action value function by using the QE (step S1403). Furthermore, the action determining apparatus 100 determines the action aₜ by executing an action determining processing which will be described later in FIG. 15 or FIG. 16 based on the optimum action aₜ* (step S1404).

Next, the action determining apparatus 100 sets t to t+1 (step S1405). The action determining apparatus 100 acquires the gain rₜ₋₁ that corresponds to the action aₜ₋₁ (step S1406). Next, the action determining apparatus 100 determines whether or not to update the state action value function (step S1407). The update is performed, for example, every time a series of processing in steps S1402 to S1406 is executed N times.

In a case where the state action value function is not updated (step S1407: No), the action determining apparatus 100 returns to the processing of step S1402. Meanwhile, in a case where the state action value function is updated (step S1407: Yes), the action determining apparatus 100 updates the state action value function by using the QE (step S1408).

Next, the action determining apparatus 100 determines whether or not to end the control of the control target 110 (step S1409). In a case where the control does not end (step S1409: No), the action determining apparatus 100 returns to the processing of step S1402. Meanwhile, in a case where the control ends (step S1409: Yes), the action determining apparatus 100 ends the reinforcement learning processing. Accordingly, the action determining apparatus 100 is capable of stopping the action having a relatively low value from being determined as the next action.

In the example of FIG. 14, a case where the action determining apparatus 100 executes the reinforcement learning processing in a batch processing format has been described, but the embodiment is not limited thereto. For example, there may be a case where the action determining apparatus 100 executes the reinforcement learning processing in a sequential processing format.

Example of Action Determining Processing Procedure

Next, an example of the action determining processing procedure will be described with reference to FIG. 15.

FIG. 15 is a flowchart illustrating an example of the action determining processing procedure. In FIG. 15, the action determining apparatus 100 generates the logical expression ψ(a₁, . . . , aₙ) based on the optimum action aₜ* by using the QE (step S1501).

Next, the action determining apparatus 100 randomly initializes a=(a₁, . . . , aₙ) (step S1502). Then, the action determining apparatus 100 determines whether or not a=(a₁, . . . , aₙ) satisfies the logical expression ψ (step S1503).

In a case where the logical expression ψ is not satisfied (step S1503: No), the action determining apparatus 100 returns to the processing of step S1502. Meanwhile, in a case where the logical expression ψ is satisfied (step S1503: Yes), the action determining apparatus 100 proceeds to the processing of step S1504.

In step S1504, the action determining apparatus 100 determines a=(a₁, . . . , aₙ) as the action aₜ (step S1504). Then, the action determining apparatus 100 ends the action determining processing. Accordingly, the action determining apparatus 100 is capable of determining the next action.

Another Example of Action Determining Processing Procedure

Next, another example of the action determining processing procedure will be described with reference to FIG. 16.

FIG. 16 is a flowchart illustrating another example of the action determining processing procedure. In FIG. 16, the action determining apparatus 100 generates the logical expression ψ(a₁, . . . , aₙ) based on the optimum action aₜ* by using the QE (step S1601).

Next, the action determining apparatus 100 randomly selects i from i=1, . . . , n until the value aᵢ becomes i that has not yet been determined (step S1602). Then, the action determining apparatus 100 applies the QE to φᵢ(aᵢ) indicated by the following equation (25) (step S1603).

φᵢ(aᵢ):=∃a₁ . . . ∃aᵢ₋₁∃aᵢ₊₁ . . . ∃aₙψ (25)

Next, based on the result of applying the QE, the action determining apparatus 100 expresses φᵢ(aᵢ) in a format of the interval sum illustrated by the following equation (26) (step S1604).

φᵢ(aᵢ)=l₁≤aᵢ≤h₁∨ . . . ∨lₘ≤aᵢ≤hₘ (26)

Next, the action determining apparatus 100 selects j from j=1, . . . , m with the probability illustrated by the following expression (27) (step S1605).

$$\frac{{h}_{j} - {l}_{j}}{{\sum }_{k = 1}^{m} ( {h}_{k} - {l}_{k} )} \qquad ( 27 )$$

Next, the action determining apparatus 100 randomly selects aᵢ from a region illustrated by the following expression (28) that corresponds to the selected j (step S1606).

lⱼ≤aᵢ≤hⱼ (28)

Next, the action determining apparatus 100 substitutes the selected aᵢ for the logical expression ψ (step S1607). Then, the action determining apparatus 100 determines whether or not all i have been selected (step S1608). In a case where there is an unselected i (step S1608: No), the action determining apparatus 100 returns to the processing of step S1602. Meanwhile, in a case where all i are selected (step S1608: Yes), the action determining apparatus 100 ends the action determining processing. Accordingly, the action determining apparatus 100 is capable of determining the next action.

As described above, according to the action determining apparatus 100, it is possible to obtain the optimum action related to the state action value function. According to the action determining apparatus 100, it is possible to specify the action range by applying the QE for the logical expression including the conditional expression that represents that the difference between the value of the state action value function and the value of the state action value function that corresponds to the optimum action is smaller than a threshold value, and determine the next action from the specified range. Accordingly, even when the action is treated as a continuous quantity, when estimating the state action value function, in a case of determining the action on the control target 110, the action determining apparatus 100 is capable of stopping the action having a relatively low value from being determined.

According to the action determining apparatus 100, it is possible to include the conditional expression that represents the possible range of the action in the logical expression. Accordingly, the action determining apparatus 100 is capable of determining a preferable action on the control target 110, which satisfies the conditional expression that represents the possible range of the action, and efficiently controlling the control target 110.

According to the action determining apparatus 100, it is possible to include the conditional expression that represents that the Euclidean distance between the action and the optimum action is larger than the threshold value in the logical expression. Accordingly, the action determining apparatus 100 is capable of trying the next preferable action on the control target 110 even when the action is more than a certain distance away from the optimum action determined to be currently optimum, and is capable of accurately estimating the state action value function.

According to the action determining apparatus 100, it is possible to acquire the input value related to the state and the input value related to the action, and the gain that corresponds to the input value related to the action, and to estimate the coefficient of the state action value function based on the acquired input value and the gain. According to the action determining apparatus 100, it is possible to obtain the optimum action related to the state action value function with the estimated coefficient by using the QE. Accordingly, in the action determining apparatus 100, in the reinforcement learning, it is possible to treat the action as a continuous quantity, to finely adjust the action, and to efficiently control the control target 110. Further, the action determining apparatus 100 is capable of suppressing an increase in the time required for the reinforcement learning.

According to the action determining apparatus 100, it is possible to estimate the coefficient of the state action value function by using the QE based on the acquired input value and gain. Accordingly, the action determining apparatus 100 is capable of improving the state action value function by estimating the coefficient of the state action value function even in a case of solving the optimization problem when obtaining the coefficient of the state action value function.

According to the action determining apparatus 100, it is possible to obtain the optimum action related to the state action value function to which a conditional expression that represents the possible range of the action is applied and of which the coefficient is estimated, by using the QE. Accordingly, in the action determining apparatus 100, it is possible to use the condition that represents the possible range of the action in the reinforcement learning, and to control the control target 110 by accurately considering the properties of the control target 110.

According to the action determining apparatus 100, it is possible to obtain the optimum action related to the state action value function using the predetermined coefficient by using the QE. Accordingly, the action determining apparatus 100 is capable of obtaining the optimum action or the optimum value even at a time point when the coefficient of the state action value function has not been estimated yet.

According to the action determining apparatus 100, in a case where the state action value function is linear with respect to the action, the action determination unit 503 is capable of obtaining the optimum action by using calculation software of a linear programming problem. Accordingly, the action determining apparatus 100 is capable of obtaining the optimum action without using the QE.

According to the action determining apparatus 100, in a case where the state action value function is convex, the action determination unit 503 is capable of obtaining the optimum action by using calculation software of a steepest gradient method. Accordingly, the action determining apparatus 100 is capable of obtaining the optimum action without using the QE.

According to the action determining apparatus 100, it is possible to randomly select the action, and determine the selected action as the next action when the selected action is within the range. Accordingly, the action determining apparatus 100 is capable of determining the action within the specified range as the next action.

According to the action determining apparatus 100, it is possible to determine the next action by using the QE for the specified range. Accordingly, the action determining apparatus 100 is capable of determining the action within the specified range as the next action. The action determining apparatus 100 is capable of reducing the processing amount for determining the next action regardless of the size of the specified action range.

In addition, it is possible to realize the action determining method described according to the embodiment by causing a computer, such as a personal computer or a workstation, to execute a prepared program. The action determining program described according to the embodiment is recorded on a computer-readable recording medium, such as a hard disk, a flexible disk, a compact disc read-only memory (CD-ROM), a magneto-optical (MO) disc, or a digital versatile disc (DVD), and is executed as a result of being read from the recording medium by a computer. The action determining program described according to the present embodiment may be distributed through a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process, the process comprising:
obtaining, for a control target, a specific action related to a value function that becomes a polynomial expression for a variable that represents an action or a polynomial expression for a variable that represents an action when a value is substituted for a variable that represents a state;
specifying an action range by using a quantifier elimination for a logical expression including a conditional expression that represents that a difference between a value of the value function and a value of the value function that corresponds to the specific action is smaller than a threshold value;
determining a next action from the specified range; and
transmitting, to the control target, a control signal to effectuate the next action from the specified range.

2. The non-transitory computer-readable recording medium having stored therein the program according to claim 1,
wherein the logical expression further includes a conditional expression that represents a possible range of the action.

3. The non-transitory computer-readable recording medium having stored therein the program according to claim 1,
wherein the logical expression further includes a conditional expression that represents that a Euclidean distance between an action and the specific action is larger than a threshold value.

4. The non-transitory computer-readable recording medium having stored therein the program according to claim 1, wherein the process further comprises:
acquiring an input value related to a state and an input value related to an action, and a gain that corresponds to the input value related to the action, and
estimating a coefficient of the value function based on the acquired input values and the gain, and
wherein the obtaining obtains the specific action related to the value function of which the coefficient is estimated by using a quantifier elimination.

5. The non-transitory computer-readable recording medium having stored therein the program according to claim 4,
wherein the estimating estimates a coefficient of the value function by using a quantifier elimination based on the acquired input values and the gain.

6. The non-transitory computer-readable recording medium having stored therein the program according to claim 4,
wherein the obtaining obtains the specific action related to the value function to which a conditional expression that represents a possible range of an action is applied and of which the coefficient is estimated, by using a quantifier elimination.

7. The non-transitory computer-readable recording medium having stored therein the program according to claim 4,
wherein the obtaining obtains the specific action related to the value function using a predetermined coefficient by using a quantifier elimination.

8. The non-transitory computer-readable recording medium having stored therein the program according to claim 1,
wherein the obtaining obtains the specific action by using calculation software of a linear programming problem in a case where the value function is linear with respect to an action.

9. The non-transitory computer-readable recording medium having stored therein the program according to claim 1,
wherein the obtaining obtains the specific action by using calculation software of a steepest gradient method in a case where the value function is convex.

10. The non-transitory computer-readable recording medium having stored therein the program according to claim 1,
wherein the determining randomly selects an action and determines the selected action as the next action when the selected action is within the range.

11. The non-transitory computer-readable recording medium having stored therein the program according to claim 1,
wherein the determining determines the next action by using a quantifier elimination for the specified range.

12. An action determining method executed by a computer, the method comprising:
obtaining, for a control target, a specific action related to a value function that becomes a polynomial expression for a variable that represents an action or a polynomial expression for a variable that represents an action when a value is substituted for a variable that represents a state;
specifying an action range by using a quantifier elimination for a logical expression including a conditional expression that represents that a difference between a value of the value function and a value of the value function that corresponds to the specific action is smaller than a threshold value;
determining a next action from the specified range; and
transmitting, to the control target, a control signal to effectuate the next action from the specified range.

13. An action determining apparatus comprising:
a memory,
a processor coupled to the memory and the processor configured to:
obtain, for a control target, a specific action related to a value function that becomes a polynomial expression for a variable that represents an action or a polynomial expression for a variable that represents an action when a value is substituted for a variable that represents a state;
specify an action range by using a quantifier elimination for a logical expression including a conditional expression that represents that a difference between a value of the value function and a value of the value function that corresponds to the specific action is smaller than a threshold value;
determine a next action from the specified range; and
transmit, to the control target, a control signal to effectuate the next action from the specified range.
